(19) United States
(12) Patent Application Publication
(10) Pub. No.: US 2010/0116364 A1
(43) Pub. Date: May 13, 2010

(54) BACKFLOW PREVENTION DEVICE

(75) Inventor: Fumitoshi KOYAMA, Kariya-shi (JP)

Correspondence Address: BUCHANAN, INGERSOLL & ROONEY PC, POST OFFICE BOX 1404, ALEXANDRIA, VA, 22313-1404, US

(73) Assignee: ADVICS CO., LTD., Kariya-city (JP)

(21) Appl. No.: 12/611,963

(22) Filed: Nov. 4, 2009

(30) Foreign Application Priority Data
Nov. 13, 2008 (JP) 2008-290453

(51) Int. Cl. F16K 15/00

(52) U.S. Cl. 137/535

(57) ABSTRACT

A backflow prevention device includes a check valve including a valve body and a valve seat, an enclosure member retained by a peripheral member and arranged at a downstream side of the valve body, the enclosure member including an entrance facing an upstream side and being formed into a cylindrical shape having a bottom wall, the enclosure member into which the valve body is inserted via the entrance, the enclosure member having an inner diameter for guiding an outer periphery of the valve body, the upstream side corresponding to a direction where the fluid flows into the check valve while the downstream side corresponding to a direction where the fluid flowing into the check valve flows out therefrom, and a bypass passage provided at an outer periphery of the enclosure member, the bypass passage through which the fluid passing through a valve portion of the check valve flows.

### CROSS REFERENCE TO RELATED APPLICATIONS

This application is based on and claims priority under 35 U.S.C. §119 to Japanese Patent Application 2008-290453, filed on Nov. 13, 2008, the entire content of which is incorporated herein by reference.

### FIELD OF THE INVENTION

The present invention relates to a backflow prevention device.

### BACKGROUND

A backflow prevention for a fluid is achieved by providing a check valve (a back-flow valve) including a valve body and a valve seat connected to or disconnected from each other at a fluid passage. The check valve is classified into two types in which the valve body is biased by an elastic member in one direction to be pressed against the valve seat and in which the valve body makes contact with the valve seat by means of a negative pressure or gravity.

The check valve is generally provided at the fluid passage connected to an outlet port and/or an inlet port of a power pump. In a brake hydraulic pressure control apparatus, in view of securing reliability, it is required to prevent a fluid suctioned to a pump chamber of the power pump or a fluid discharged from the pump chamber from back-flowing. Thus, a backflow prevention device using the check valve is necessary.

According to a backflow prevention device disclosed in JP3413130B (hereinafter referred to as Reference 1), check valves are provided at an inlet port and an outlet port of a piston pump, respectively. The fluid, which passes through the check valve at the outlet port, flows from a chamber in which a valve body (valve ball) is accommodated, through a lateral bore formed at a closure plug, to an outlet bore formed at a pump casing.

According to a backflow prevention device disclosed in JPH07-32266U (hereinafter referred to as Reference 2), a valve flow passage is defined around a valve body having a ball shape. Then, an annular-shaped ring portion is provided at an inner side of a valve guide where the valve flow passage is provided. The valve body is guided by a cylindrical inner surface of the annular ring portion accordingly.

The pump repeats suction and compression for pumping the fluid. Thus, a pulsation of the pressure of the fluid suctioned to the pump chamber or the fluid compressed in the pump chamber and then discharged therefrom is inevitably in association with a cycle of suction and compression. In a brake hydraulic pressure control apparatus for a vehicle, such pulsation should be avoided and therefore a dumper is provided between the pump and an actuator to which the hydraulic pressure is applied from the pump to thereby attenuate the pulsation. However, because the dumper is provided at a downstream side relative to the check valve at the outlet port of the pump (i.e., in a direction close to the actuator), the check valve is influenced by the pulsation.

The check valve disclosed in Reference 1 has no function for reducing the pulsation. The check valve disclosed in Reference 2 also does not exercise a function for reducing the pulsation.

Specifically, according to the structure of each of the check valves disclosed in References 1 and 2, a Karman vortex may occur at a rear side (i.e., downstream side) of the valve body, which may lead to a facilitation of the pulsation. Because the fluid flows along a surface of the valve body, the Karman vortex may possibly occur.

In addition, according to the check valve disclosed in Reference 2, a vibration of the valve body in a radial direction thereof is restrained by the annular ring portion. However, the vibration of the valve body in an axial direction thereof is allowed. The fluid passing through the valve fluid passage returns to the rear side of the valve body and then flows in a direction to move the valve body. Thus, the valve body may be influenced by a flow of the fluid. According to References 1 and 2, the pulsation of the fluid may be directly or increasingly transmitted to the actuator, to which the fluid pressure is applied, provided at the downstream side.

A need thus exists for a backflow prevention device which is not susceptible to the drawback mentioned above.

### SUMMARY OF THE INVENTION

According to an aspect of the present invention, a backflow prevention device includes a check valve including a valve body and a valve seat connected to and disconnected from each other, the check valve being arranged at a fluid passage through which a fluid flows, and an enclosure member retained by a peripheral member and arranged at a downstream side of the valve body. The enclosure member includes an entrance facing an upstream side and is formed into a cylindrical shape having a bottom wall, the enclosure member into which the valve body is inserted via the entrance. The enclosure member has an inner diameter for guiding an outer periphery of the valve body. The upstream side corresponds to a direction where the fluid flows into the check valve while the downstream side corresponds to a direction where the fluid flowing into the check valve flows out therefrom. The backflow prevention device further includes a bypass passage provided at an outer periphery of the enclosure member, the bypass passage through which the fluid passing through a valve portion of the check valve flows.

### BRIEF DESCRIPTION OF THE DRAWINGS

The foregoing and additional features and characteristics of the present invention will become more apparent from the following detailed description considered with the reference to the accompanying drawings, wherein:

FIG. 1 is a cross-sectional view of a main portion of a backflow prevention device according to a first embodiment;

FIG. 2 is a side view of the backflow prevention device shown in FIG. 1 viewed from a downstream side (right side in FIG. 1);

FIG. 3 is an explanation view of the backflow prevention device shown in FIG. 1;

FIG. 4 is a cross-sectional view of a main portion of a backflow prevention device according to a second embodiment; and

FIG. 5 is an explanation view of the backflow prevention device shown in FIG. 4.

### DETAILED DESCRIPTION

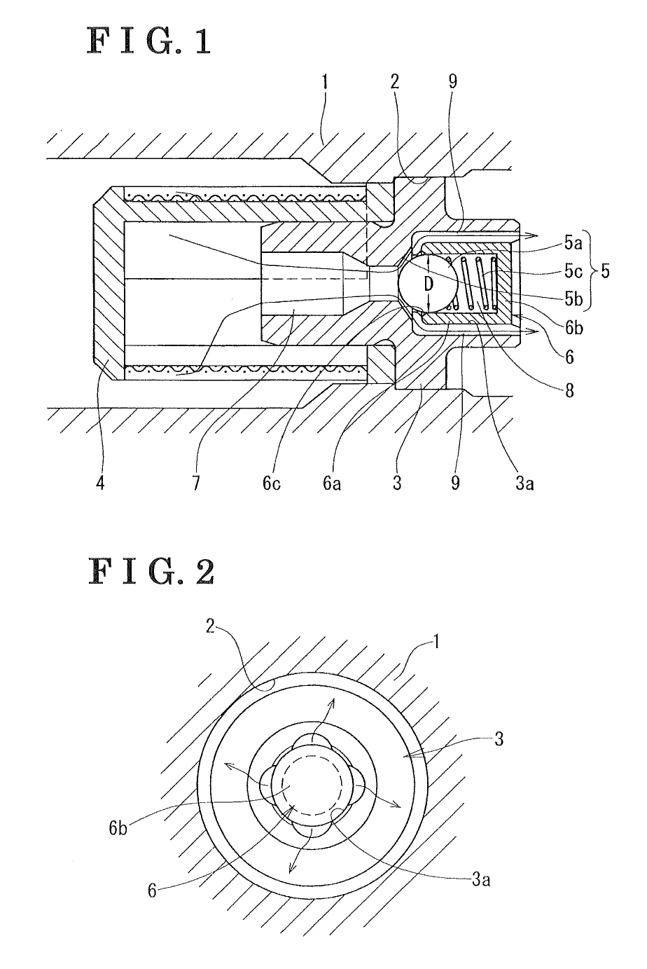

A first embodiment will be explained with reference to FIGS. 1 to 3. As illustrated in FIGS. 1 and 2, a backflow prevention device according to the first embodiment includes a housing 1, a plug 3, a filter 4, a check valve 5, and an enclosure member 6. The housing 1 includes an assembly hole 2. The plug 3 is provided at an inner side of the assembly hole 2 of the housing 1. The filter 4 is mounted on the plug 3. The check valve 5 is incorporated at an inner side of the plug 3. The filter 4 is a member provided when needed and is not essential. The enclosure member 6 is a feature of the present embodiment.

In a case where the housing 1 serves as a housing for a brake hydraulic pressure control apparatus, for example, a pump is incorporated within the housing 1. A fluid passage 7 connected to an inlet port and/or an outlet port of the pump is provided at an inner side of the housing 1. The check valve 5 is provided at the fluid passage 7.

The plug 3 is fixed to the inside of the assembly hole 2 by means of an arbitrary method. Specifically, the plug 3 is fixed to the assembly hole 2 by means of a known method such as a press-fitting, a riveting, and a holding by a snap ring. A hole 3a constituting a portion of the fluid passage 7 is formed at the plug 3 so as to penetrate through an axial center of the plug 3. The check valve 5 and the enclosure member 6 are assembled on the hole 3a.

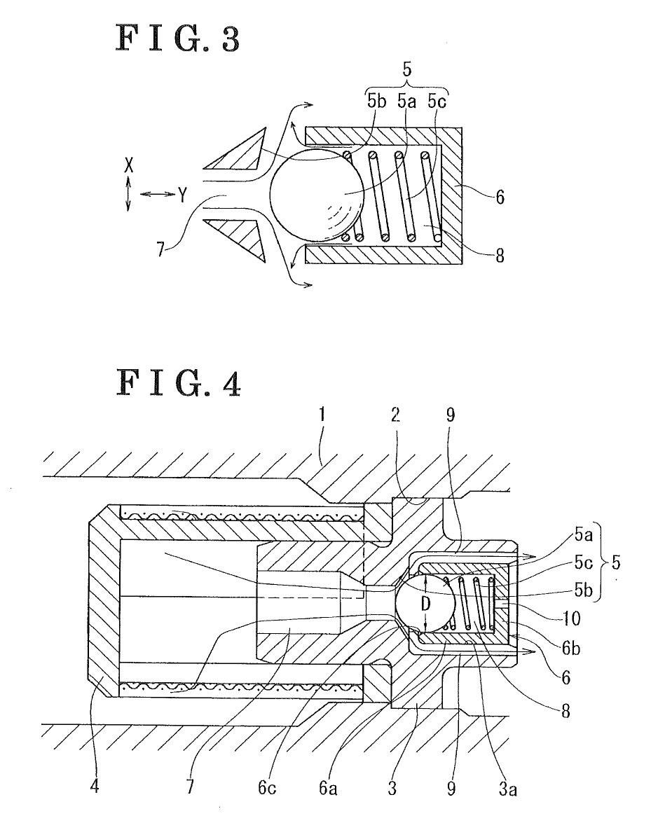

The check valve 5 includes a valve body 5a, a valve seat 5b, and an elastic member 5c. The valve seat 5b is provided at a portion of the hole 3a of the plug 3 in a longitudinal direction thereof. The elastic member 5c biases the valve body 5a in one direction (i.e., a left direction in FIG. 1). In a case where the pressure of the fluid passing through the check valve 5 is equal to or smaller than a predetermined value, the elastic member 5c presses the valve body 5a against the valve seat 5b. The elastic member 5c in FIGS. 1 and 3 is a compression coil spring. The check valve 5 may move the valve body 5a to a closed position by means of gravity or a negative pressure generated in a pump chamber, and the like. The elastic member 5c is not an essential member according to the present embodiment.

A diameter D of the valve body 5a of the check valve 5 is slightly smaller than an inner diameter of a cylindrical portion 6a at an entrance 6c (which will be explained later) of the enclosure member 6. A small gap functioning as an orifice is thus formed between an outer periphery of the valve body 5a and an inner periphery of the cylindrical portion 6a at the entrance 6C (see FIG. 3). The valve body 5a illustrated in FIG. 1 is a spherical body, however, it may be a non-spherical body such as a poppet valve.

The enclosure member 6 is formed into a cylindrical shape having a bottom wall. Specifically, the enclosure member 6 includes the cylindrical portion 6a, a bottom wall 6b, and the entrance 6c. An opening end of the enclosure member 6 serves as the entrance 6c. The enclosure member 6 is arranged at a fixed position in such a manner that the entrance 6c of the enclosure member 6 faces an upstream side. The plug 3 serves as a peripheral member of the enclosure member 6 which is inserted into the hole 3a of the plug 3. The enclosure member 6 is fixed to the plug 3 by means of a known method such as a press-fitting, a riveting, and a holding by means of a snap ring in the same way as the fixation of the plug 3 to the housing 1.

The entrance 6c of the enclosure member 6 is positioned close to the upstream side relative to a maximum diameter portion of the valve body 5a when the check valve 5 is in an open state. The enclosure member 6 also serves as a spring retainer for supporting one end of the elastic member 5c.

A chamber 8 is formed, being surrounded by the enclosure member 6 at a downstream side of the valve body 5a. The fluid is introduced to the chamber 8. In the above explanation, the upstream side corresponds to one direction where the fluid flows into the check valve 5. In addition, the downstream side corresponds to the other direction where the fluid flowing into the check valve 5 flows out therefrom (i.e., in FIG. 1, the upstream side is a left side of the check valve 5 while the downstream side is a right side of the check valve 5).

Multiple bypass passages 9 are arranged at an outer periphery of the enclosure member 6 at intervals in a peripheral direction. The bypass passages 9 are provided for connecting the upstream side and the downstream side of the fluid passage 7 relative to the enclosure member 6. The fluid that pushes and moves the valve body 5a of the check valve 5 to the open position and that passes through a passage between the valve body 5a and the valve seat 5b flows to the downstream side via the bypass passages 9.

According to the backflow prevention device shown in FIG. 1 having the aforementioned structure, in a case where a pulsation component is included in the fluid passing through the check valve 5, the valve body 5a is likely to vibrate when receiving the pulsation component. In addition, a vortex may occur in the fluid that passes through a vicinity of the valve body 5a, which leads to the vibration of the valve body 5a. At this time, the vibration of the valve body 5a in a radial direction thereof is restrained by the enclosure member 6. As illustrated in FIG. 3, the vibration in a direction X (i.e., in the radial direction of the valve body 5a) is limited within the gap formed between the enclosure member 6 and the maximum diameter portion of the valve body 5a.

Further, the vibration of the valve body 5a in an axial direction thereof is restrained by means of the fluid blocked in the chamber 8 functioning as a buffer. In a case where the valve body 5a moves in a rightward direction in FIG. 3, the fluid within the chamber 8 is pushed out from the chamber 8. However, the gap formed between the enclosure member 6 and the outer periphery of the valve body 5a is small and thus an orifice effect is exerted by the gap. The buffer effect by the fluid within the chamber 8 increases to thereby restrain the vibration of the valve body 5a in a direction Y in FIG. 3 (i.e., in the axial direction of the valve body 5a). The pulse component in the fluid is effectively absorbed accordingly.

Because the entrance 6c of the enclosure member 6 is positioned at the upstream side relative to the maximum diameter portion of the valve body 5a in a case where the check valve 5 is in the open state and the size of the gap formed between the enclosure member 6 and the valve body 5a is constant, the orifice effect by the aforementioned gap is substantially constant. As a result, the orifice effect is substantially constant, thereby exercising the stable pulsation reduction.

Further, the fluid passing through a valve portion of the check valve 5 flows through the bypass passages 9 to the downstream side by bypassing the chamber 8. Thus, the fluid flow is not generated along a surface of a portion of the valve body 5a covered by the enclosure member 6. The operation of the valve body 5a is prevented from being unstable by an influence of the Karman vortex, and the like, thereby also enhancing the effect of the pulsation reduction.

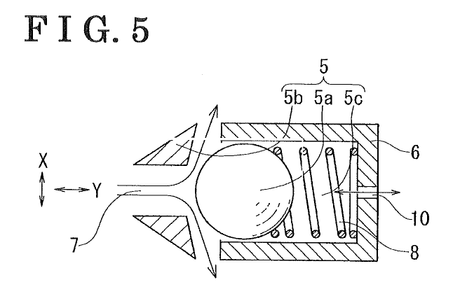

A second embodiment will be explained with reference to FIGS. 4 and 5. A backflow prevention device according to the second embodiment includes an orifice 10 at the bottom wall 6b of the enclosure member 6. Other structures of the second embodiment than the orifice 10 are same as those of the first embodiment. Thus, the same structures of the second embodiment bear the same reference numerals as those of the first embodiment and an explanation thereof will be omitted.

The orifice 10 is arranged at a portion of the bottom wall 6b facing a radially inner portion of the elastic member (compression coil spring) 5c. The orifice 10 connects the chamber 8 formed within the enclosure member 6 to the fluid passage 7 arranged at the downstream side of the enclosure member 6 and separated from the chamber 8 by means of the bottom wall 6b. The orifice 10 achieves the orifice effect for causing the fluid within the chamber 8 to function as a buffer, without depending on the gap formed between the enclosure member 6 and the outer periphery of the valve body 5a. As illustrated in FIG. 5, the fluid flows in and out from the chamber 8 through the orifice 10 and does not necessarily flow through the aforementioned gap. Thus, the gap formed between the enclosure member 6 and the outer periphery of the valve body 5a is minimized within a range where the movement of the valve body 5a in the gap is not interfered. The minimized gap achieves the small movement of the valve body 5a in the radial direction thereof, which leads to the improved guiding effect of the enclosure member 6 relative to the valve body 5a. In addition, because the fluid flows in and out from the chamber 8 without passing through a coil wire rod of the compression coil spring (elastic member) 5c, the vibration generated in the coil wire rod of the compression coil spring (elastic member) 5c caused by the flow of the fluid is prevented.

A hole diameter of the orifice 10 according to the second embodiment, the size of the gap between the enclosure member 6 and the outer periphery of the valve body 5a according to the first embodiment, and the like are appropriately specified in view of the magnitude of the pulsation component of the fluid, an applied condition of the backflow prevention device, and the like.

The backflow prevention device according to the aforementioned first or second embodiment is applicable to various types of hydraulic pressure control apparatus such as a brake hydraulic pressure control apparatus in which a pump, an electromagnetic valve for hydraulic pressure control, and the like are assembled, a power steering pump, a fuel pump, and the like.

In a case where the backflow prevention device according to the aforementioned first or second embodiment is applied to a pump such as a gear pump in which a fluid pulsation is smaller than that of a piston pump, and the like, a total pulsation reduction effect achieved by the backflow prevention device and the pump, in addition to the high pulsation reduction effect obtained by the present backflow prevention device itself, is specifically remarkable. That is, if a backflow prevention device having a relatively low pulsation reduction effect is applied to a pump having a small pulsation such as a gear pump, a total pulsation reduction effect achieved by the backflow prevention device and the pump may increase because of the large pulsation of the backflow prevention device even though the pulsation of the pump is small. In such case, the application of the backflow prevention device having the high pulsation reduction effect according to the embodiments achieves the excellent pulsation reduction effect.

According to the backflow prevention device of the first and second embodiments, the fluid flow along the surface of the valve body 5a is blocked by the enclosure member 6 provided at the downstream side (rear side) of the valve body 5a. In addition, the vibration of the valve body 5a in the radial direction thereof is restrained by the enclosure member 6. Further, the vibration of the valve body 5a in the axial direction thereof is restrained by the fluid, serving as a buffer, flowing into the chamber 8 inside of the enclosure member 6. The fluid in the chamber 8 within the enclosure member 6 functions as a buffer because of the following reason. That is, the fluid within the chamber 8 is pushed out of the enclosure member 6 in a case where the valve body 5a moves in the open direction. At this time, the pushing-out of the fluid is restrained by the orifice effect obtained by the gap formed between the enclosure member 6 and the valve body 5a. According to such operation, the fluid pulsation is attenuated to thereby decrease the pulsation transmitted to the downstream side of the check valve 5.

The entrance 6c of the enclosure member 6 is positioned at the upstream side relative to a maximum diameter portion of the valve body 5a in a case where the check valve 5 is in an open state.

The size of the gap formed between the enclosure member 6 and the outer periphery of the valve body 5a is constant regardless of the positional change of the valve body 5a. The stable effect of the pulsation reduction is obtained by the check valve 5 accordingly.

The backflow prevention device further includes the orifice 10 formed at the bottom wall 6b of the enclosure member 6 for connecting the chamber 8 defined within the enclosure member 6 to the fluid passage 7 separated from the chamber 8 by means of the bottom wall 6b.

Accordingly, the orifice effect for causing the fluid within the chamber 8 to function as a buffer is obtainable independent from the gap between the enclosure member 6 and the outer periphery of the valve body 5a. Thus, the gap between the enclosure member 6 and the outer periphery of the valve body 5a is minimized within a range where the movement of the valve body 5a is not interfered. The guiding effect of the enclosure member 6 relative to the valve body 5a is enhanced accordingly.

The check valve 5 includes the elastic member 5c biasing the valve body 5a in one direction to press the valve body 5a against the valve seat 5b, one end of the elastic member 5c being supported by the enclosure member 6.

The enclosure member 6 also functions as a retainer for holding the elastic member 5c so as to contribute to the reduction of the number of components.

The elastic member 5c includes the compression coil spring disposed between the valve body 5a and the bottom wall 6b of the enclosure member 6, and the orifice 10 is formed at the enclosure member 6 at a portion facing a radially inner portion of the elastic member 6c (compression coil spring), the orifice 10 connecting the chamber 8 defined within the enclosure member 6 to the fluid passage 7 separated from the chamber 8 by means of the bottom wall 6b.

In a case where the valve body 5a moves in a reciprocating manner within the enclosure member 6, the fluid flows in and out from the chamber 8 via the orifice 10 without passing through a gap formed in the wire rod of the compression coil spring (elastic member) 5c. Thus, possible generation of vibration in the coil wire rod of the compression coil spring 5c by means of the fluid passing through the gap in the coil wire rod is restrained.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A backflow prevention device comprising:
a check valve including a valve body and a valve seat connected to and disconnected from each other, the check valve being arranged at a fluid passage through which a fluid flows;
an enclosure member retained by a peripheral member and arranged at a downstream side of the valve body, the enclosure member including an entrance facing an upstream side and being formed into a cylindrical shape having a bottom wall, the enclosure member into which the valve body is inserted via the entrance, the enclosure member having an inner diameter for guiding an outer periphery of the valve body, the upstream side corresponding to a direction where the fluid flows into the check valve while the downstream side corresponding to a direction where the fluid flowing into the check valve flows out therefrom; and
a bypass passage provided at an outer periphery of the enclosure member, the bypass passage through which the fluid passing through a valve portion of the check valve flows.

2. The backflow prevention device according to claim 1, wherein the entrance of the enclosure member is positioned at the upstream side relative to a maximum diameter portion of the valve body in a case where the check valve is in an open state.

3. The backflow prevention device according to claim 1, further comprising an orifice formed at a bottom wall of the enclosure member for connecting a chamber defined within the enclosure member to the fluid passage separated from the chamber by means of the bottom wall.

4. The backflow prevention device according to claim 1, wherein the check valve includes an elastic member biasing the valve body in one direction to press the valve body against the valve seat, one end of the elastic member being supported by the enclosure member.

5. The backflow prevention device according to claim 4, wherein the elastic member includes a compression coil spring disposed between the valve body and a bottom wall of the enclosure member, and an orifice is formed at the enclosure member at a portion facing a radially inner portion of the compression coil spring, the orifice connecting a chamber defined within the enclosure member to the fluid passage separated from the chamber by means of the bottom wall.
